(19) United States
(12) Patent Application Publication
(10) Pub. No.: US 2004/0002908 A1
(43) Pub. Date: Jan. 1, 2004

(54) Method of increasing return to owners of income property with intent to reach ultimate goal of zero mortgage debt without major financial stress

(76) Inventor: Arthur James, Marina Del Rey, CA (US)

Correspondence Address: LACKENBACH SIEGEL, One Chase Road, Scarsdale, NY, 10583, US

(21) Appl. No.: 10/183,280

(22) Filed: Jun. 26, 2002

(51) Int. Cl. G06F 17/60

(52) U.S. Cl. 705/35; 705/1

(57) ABSTRACT

A method of partially transferring non-cash equity in income property with lease income servicing mortgage debt to a tax-exempt educational institution while providing the advantage of being able to withstand major taxes in the later years of a mortgage while assisting in achieving most owners' goals of obtaining debt-free free property.

### BACKGROUND OF THE INVENTION

1. Field of the Invention

The present invention generally relates to a method of servicing a self-amortizing mortgage on investment real estate and, more specifically, to a method of allowing the retention of a property by an owner for a longer term and increasing returns while allowing owners to reach zero debt against the property, creating financial relief/profits to colleges and possibly reducing the amount of ever-increasing needed educational grants by the Federal and State Governments while complying with the U.S. tax laws, specifically Title 26 of the United States Code (“U.S.C.”).

2. Description of the Prior Art

When property is leased, the owner of the property receives income. However, the extent to which such lease income can be retained by the owner is a function of numerous factors including expenses in the operation of property, depreciation, income taxes payable, etc. When property is subject to a mortgage, additional factors that determine the extent to which lease income can be retained, and whether the property will generate a “positive” or “negative” cash flow, will also be a function of the terms of the mortgage, assuming the property's continuing leases over long periods of time.

It is well known in connection with self-amortizing mortgages, payments are commonly equal throughout the term of the mortgage. However, a greater percentage of the monthly payments made by the owner of the property are primarily attributable to interest in the initial periods of the mortgage than in the later periods of the mortgage. As the mortgage approaches its final years, more and more of the mortgage payments are allocated to paying off the principal against the mortgage. Since interest payments are a deductible expense, the early periods of the mortgage provide the owner with a substantial deduction against lease income thereby reducing the beginning amount of income taxes payable, if any, by the owner. With time, less and less of the payments are used to pay interest since the principal is being reduced or amortized. Therefore, less and less of the mortgage payments attributable to interest become deductible against income, thus, the greater the level of taxation of such income in later years of mortgages. Depending on various factors, including the size and terms of the mortgage in relation to the owner's income, the resulting taxes due to lease income can become so significant in such later years of a mortgage, prior to its being extinguished, that significant amounts are needed to be paid for taxes, with associated costs to carry tax outlay (costs meaning interest and/or loss of opportunity). Such taxes and carrying costs can become so significant that the resulting net income that remains for the owner can be reduced to zero, or actually become negative, frequently requiring an owner to dispose of the property. As important, considering the burden of those payments, it is quite rare with income property for owners to be able to sustain those payments in reaching the ultimate goal in real estate, namely, owning mortgage-free property.

For purposes of this application, the term “phantom income” signifies income received by an owner of a property that must then be paid in taxes, so that it is as though the income never existed. “Phantom income tax,” for purposes of the present application, is a tax to be paid by an owner when income exceeds the combination of interest, expenses, and depreciation. The owner is taxed on excess income according to his or her tax bracket. The time when the owner starts to be taxed on the lease income is commonly termed the “cross-over” period.

Once the cross-over period has been reached, as noted, substantial levels of taxes may become due yearly. This makes it very difficult, if not impossible, for the owner to maintain a property unless he or she is in a position to fund the ever-increasing yearly income taxes from independent sources or savings.

Common methods of servicing mortgages and avoiding phantom income tax have been proposed. Commonly used methods used by owners who prefer to avoid phantom income tax do not achieve the ultimate goal of owning a mortgage-free property. For example, owners have re-financed a primary mortgage. Thus, the re-financing of an existing primary mortgage bearing an interest (including depreciation and expenses) sufficient to offset existing phantom income has been attempted. This approach is actually a way of “going backwards” with regard to the ultimate goal of zero mortgage debt because re-financing is rarely fully amortized.

In some instances, new secondary financing is sought. This type of financing commonly allows for short-term balloon conditions, personal liability, significantly higher rates, charges, and costs, and, as important, very difficult to obtain due to the required need of long-term borrowing immaterial of security of the loan.

One popular approach has been the “1031 Exchange.” This approach is the most common one used, and functions by satisfying Section 1031 of the Internal Revenue Code (“IRC”). However, many of the following preferred factors may be compromised when trading property:

a. Financial condition or rating of the tenant or tenant(s);

b. Equal income flow;

c. Equal debt amount in order to avoid “boot” or tax;

d. Existing terms and conditions of acquired debt;

e. Location and demographics;

f. Caliber of construction and/or condition of property;

g. Equal age of property;

h. Market conditions;

i. Management requirements; and

j. Equal personal liability.

In U.S. Pat. No. 6,292,788 to Roberts et al., a method and investment instruments for performing tax-deferred real estate exchanges are disclosed that enable investors to realize substantial tax-deferred benefits in accordance with Section 1031 of the IRC. This is achieved by creating a new type of investment instrument denominated a “deed share” that represents both a tenant-in-common interest in real estate and provides divisibility and liquidity of a traditional security, such as a bond. The use of deed shares, as disclosed in this patent, allows the tenant-in-common owners of the real estate not to be deemed partners, and investors may then use IRC Section 1031 to perform tax-deferred exchanges. In this way, deed shares receive a guaranteed income from a master lease and yearly depreciation without having to maintain or manage the real estate. The deedshares are designed to qualify as interests in investment real estate and, therefore, they are eligible for tax-deferred treatment under Section 1031 of the IRC. However, Section 1031 exchanges merely provide that no gain or loss will be recognized on the exchange of any type of business use or investment property for any other business use or investment property. Typically, Section 1031 exchanges are sales and purchases that involve the same exact ingredients as any other sale or purchase, without the capital gains. The only difference is that the investor increases his selling and buying power by electing to avoid the drain of taxes under Section 1031 regulations. The major benefit of a Section 1031 exchange is the deferral of taxes. By deferring taxes, a taxpayer can reinvest the profits and appreciation in market value while at the same time avoiding having the current payment of taxes erode current assets.

The key defects of use of the 1031 Exchange as contrasted to the invention are as follows:

1. Traders of property must find properties with equal or greater debt of the original property or they will be taxed.

2. Traders of property must find properties of equal or greater value or they will be taxed.

3. Traded property leases are either commonly shorter at time of trade than their initial terms or that property or those properties normally do not throw off income equal to the original property. Thus, if held will present phantom income problems again. Consequently, more beneficial financing for trader's relief via increased income cannot be obtained.

4. Most important, when employing the 1031 Exchange program, traders very seldom reach the goal of zero mortgage without the trader having financial stress during those phantom income tax years.

While Section 1031 exchanges are relatively flexible and can be used for achieving numerous objectives or goals, they do not directly address income taxes typically incurred at increasing levels late in the mortgage term as a result of lease income not being offset by the declining deductions for mortgage interest and appreciation. Declining deductions result in increased tax obligations thereby reducing cash flow. Phantom income, as indicated, which occurs when income is not equal to mortgage payments and insufficient to make tax payments, is income that simply passes through the owner as a conduit, and the owner has no benefit or use from such income. Owners typically prefer to retain their property, but do not wish (nor are they sometimes in a position) to pay income taxes when cash flow is insufficient.

### SUMMARY OF THE INVENTION

The present invention totally eliminates or substantially reduces the aforementioned owners' tax burden by having the owner contribute a portion of an interest in the real estate, normally at the time or during the cross-over period, to a tax-exempt educational organization (“Organization”) and joint venture profits from ultimate sale of property normally at the time of extinguishment of the mortgage debt and/or the initial term of lease(s) commonly in accordance with a buy-sell agreement.

The present invention substantially reduces the aforementioned tax problem by having an owner contribute on a non-cash basis, a portion of his or her interest in the real estate to a tax-exempt educational organization, such as a university or a college, normally at the beginning of the owner's phantom income tax period. Substantially concurrently therewith, a joint venture is created between the owner and the Organization. Thereafter, the property can be sold to a third party or purchased by either party to the joint venture in accordance with a buy-sell agreement.

The tax-exempt Organization will own an undivided interest in the property during the phantom income tax period in which most or all of the debt is retired with lease income.

The invention relates to a method of increasing the return to an owner of real estate income property subject to a mortgage that is usually self-amortizing over a period of years with a mortgage balance much less than the market value of the property. The invention also includes the recovery of a major portion of the owner's “dormant equity” in the property during the earlier stages of the mortgage or ownership. The invention also creates outside income for the owner due to a tax credit received by the owner from the non-cash equity donation to the institution by the owner.

The method comprises the steps of appraising the property to obtain the fair market value, which is equal to the sum of the balance on the mortgage and the owner's equity. The owner of the property then contributes, and the Organization acquires, a percentage—typically, about 50%—of the owner's non-cash equity, subject to the existing mortgage. Concurrent with the contribution, a joint venture is created between the owner and the educational organization exempt from taxation under prevailing tax laws. Since the owner does not transfer his total interest in the property and remains totally liable on the mortgage note, there is no “relief of indebtedness” to the owner. The donation to the Organization is not a taxable event to the Organization under prevailing tax laws unless it is or becomes a non-passive partner. The owner and the educational organization first agree on the present amount of owner's equity which, with the combination of net tax credit from the donation plus income derived from said credit, should be equal to at least one-half or more of the owner's equity. Since the partnership would then be substantially equal, both parties would share equally in the profits or net sale proceeds upon resale. The property and management is maintained by the owner during those years until the mortgage is at least partially or totally retired.

In the case where the owner retains 50% of the equity and becomes a 50% owner in the joint venture, 50% of normally due income taxes during the life of the joint venture are paid by the owner, representing the owner's adjusted share of the taxes. At the time of retirement of the mortgage or a reasonable balance, the property will be either sold, refinanced, and/or purchased by either party's interest in accordance with the buy-sell agreement. The net proceeds of the sale are then divided between the parties in accordance with their percentage interests in the joint venture.

Since the combination of the net after tax credit received by the owner/donor in addition to the income derived from the use of the tax credit should be at least equal to one-half or more of the owner's originally agreed equity (during the period of the venture), the resale proceeds will typically be divided equally.

In accordance with the method, the tax-exempt Organization is a college or university or other tax-exempt educational entity.

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings of preferred embodiments in which:

FIG. 1 is a block diagram illustrating the major steps of the method in accordance with the invention;

FIG. 2 is a table showing the breakdown of principal and interest allocations, depreciation, taxable income and net taxes due for each year of a holding term of a self-amortizing mortgage on a property generating a fixed lease income; and

FIG. 3 is a specimen pro forma typical transaction used in connection with the invention, in which the owner retains 50% ownership and benefits from tax credits and additional income resulting from savings due to tax credits.

### DESCRIPTION OF THE PREFERRED EMBODIMENTS

For purposes of the present invention, the following definitions will be used in the discussion below:

Residual Value or Leased Fee Interest Appraisal: This appraisal methodology is employed by all national appraisal firms and recognized by the IRS, State Taxing Agencies, and the Courts. It is commonly used on properties containing bondable leases with highly rated tenants normally above BBB+ in S&P. Most educational institutions, major real estate lenders, and nationally recognized trusts employ this method of appraisal rather than using the capitalization approach.

Bargain Sale: The term bargain sale is commonly used in two ways: (1) Sale price being less than true value relating to charitable contributions. (2) The term “bargain sale” is also a term used in determining whether or not leases are considered capital or ordinary Leases according to FASB requirements.

Contributions (Taxable & Non-Taxable Contributions): Contributions are not taxable unless donor receives other benefits in addition to sales proceeds including mortgages taken back by Sellers (Purchase Money Mortgages).

Contribution-Non-Cash (Equity Contribution): The Non-Cash Equity Contribution is based on the difference between the appraised residual value less cash and debt.

Contribution Tax Credit: The amount of allowable tax credit received by donor is based on the amount of charitable contribution as described above.

Contribution-Net Tax Credit: The net tax credit is found by multiplying the donor's tax bracket times the gross contribution. Example: Contribution: $10,000,000; Donor's Bracket: 40%; Net Tax Credit: $4,000,000.

Exchange—1031 Exchange: A transaction in which Seller may “trade” for another property, i.e., tax free trade or exchange of property.

Lease—Bondable Lease: The type of lease which totally protects Landlord by warranty from direct or indirect expenses relating to property.

Lease—Net Net Net (NNN) Lease: The type of lease (bondable) in which tenant accepts liability for all expenses relating to the property.

Effective Lease Payments: The effective lease payment is found by deducting the net after tax credit including income from said credit received by the seller/donor or tenant/donor from the actual lease payment.

Owner Non-Responsibility: This relates to investors liability for expenses, debt payments, capital calls, or any other responsibility of investor.

Owner's Dormant Equity: That equity that remains in property until sale or refinancing.

Phantom Income Tax: Tax to be paid by owner when income exceeds combination of interest and depreciation. Owner is taxed on excess income according to his or her bracket. The time when Owner is taxed is commonly termed the crossover period.

Adjusted Property Base: The original value of building less the total amount of depreciation taken during ownership.

Purchase-Straight Purchase: A common cash purchase that does not contain a donation.

Appraisal Formula: Derived by adding the net present value of all lease income during initial term of lease to the net present value of the building (at term of lease) using capitalization or corporate borrowing rate of interest whichever is greater. Said interest is also referred to as Implied Interest.

Effective Value: The increased sales value (supported by recognized appraisal firm) employing appraisal procedure (residual value appraisal methodology).

Colleges and Universities: Institutions of higher learning that satisfy Sections 401(a) and 501(c) of the IRC as tax-exempt organizations (“TEO”).

A primary objective of the present invention is for an owner of real estate income property to greatly reduce “Phantom Income Tax” during the heaviest tax periods, i.e., the time in which the heaviest principal is being reduced consequently reducing the major deductible item of interest creating ever-increasing yearly taxable income. In the latter years of a mortgage before it is fully retired, the amount of principal payment usually drops significantly while a greater and greater portion of the uniform or constant mortgage payments are normally attributed to reduction of principal. The ever-increasing loss of the important interest write-off will significantly increase the level of taxation of the income on the property. However, since other expenses in operating or managing the property remain substantially the same (as contrasted to increasing phantom income taxes) or actually slightly increase, such as maintenance, advertising, property taxes, insurance, etc., increased income taxes will significantly reduce the operating income to the point where cash flow to the owner can easily become negative. Once the major tax liability years are reached, the owner needs to supplement the income from independent sources in order to operate the property and pay the increased taxes. This is the problem that the method in accordance with the present invention addresses.

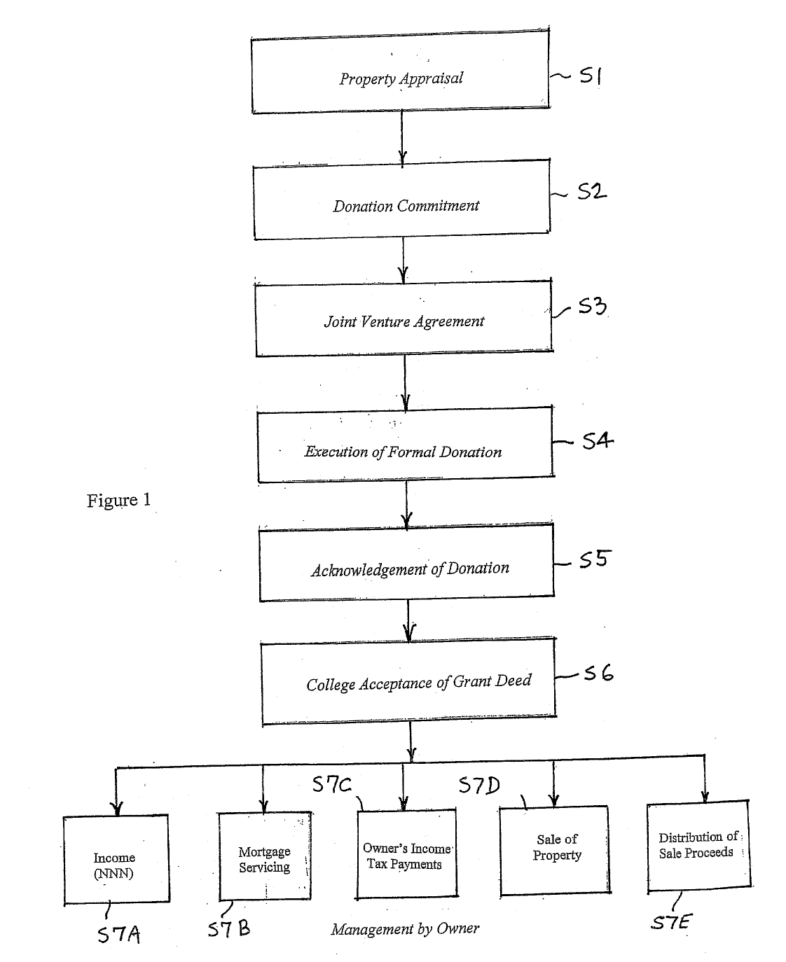

An example of the method can be summarized, in its broader aspects, by the following method and steps illustrated in FIG. 1:

1. The property is appraised in order to obtain the fair market value at S1. When the fair market value is established, less the mortgage balance, the owner's equity is determined. The owner's equity is also referred to as the “Owner's Dormant Equity.” The appraisal firm to sign IRS form 8283 (certification that the appraisal amount is the Fair Market Value of the property).

2. A Donation Commitment is made, at S2, by the owner to donate an undivided one-half interest in property to an educational organization conditioned upon execution of a Joint Venture Agreement (S3) between the owner and the institution as co-owners. The educational organization is required to be exempt from taxation under the prevailing tax laws. The extent of the donation may vary as to the percentage of the equity donated is by agreement between parties. A fifty (50%) percent donation of the owner's equity is beneficial to the donor. Owner's equity is also referred to as “Owners' Dormant Equity.” The percentage of equity donated may depend on numerous factors, including the extent to which the owner wants to benefit from the method, the extent of the write-off or deduction that the owner needs or wants to offset other income, negotiations with the educational institution, etc.

3. A Joint Venture Agreement is formed at S3 between the owner and the Organization providing for equal division of profits between the parties, on conditions agreed upon with the execution and completion of the terms and conditions provided in the Donation Commitment S2. This Joint Venture Agreement is conditioned on the Execution of Formal Donation documents, at S4. It is understood that the title to the property will be vested in the name of the owner and in the name of the Organization.

4. The owner will then formally complete the donation in accordance with the Formal Donation Agreement, at S4, of one-half of the property to the educational organization including those conditions set forth in the Donation Commitment, at S2. Thereafter, an Acknowledgement Document (Gift Receipt) is remitted to the donor by the college, at S5. The educational organization is vested with the title to property by means of a Grant Deed, at S6, to the college. A grant deed, as opposed to a recorded joint venture agreement, must be used in order to qualify for the transfer of an “undivided interest” in the property to the organization which provides the organization with a fractional interest in all the rights in the property. The owner's donation may be made concurrently with the entry into the joint venture agreement

5. The owner continues to manage the property, at S7, this includes collection of lease income, at S7A, servicing of the mortgage, at S7B, until the mortgage is nearly or totally extinguished or retired with the lease income.

6. The owner continues to pay income taxes, but now, in accordance with the invention, the owner makes payment of one-half of the joint venture income taxes, at S7C, representing the owner's share of the taxes relating to the increasing loss of interest due to the declining principal of mortgage during the phantom income period.

7. The owner sells the property, at S7D, at the termination of the mortgage and/or at initial term of lease at market in accordance with a buy-sell agreement between the parties.

8. The owner equally distributes the net sale proceeds, at S7E.

For purposes of the present invention, the prevalent tax laws will be considered those laws, regulations, rulings, etc., applicable as of the filing date of the subject application and as set forth in Internal Revenue Code (“IRC”), Title 26 of the U.S. Code, or any regulations or rulings promulgated by the Internal Revenue Service for interpreting and implementing the IRC.

For reasons that will become evident from the discussion that follows, in order for the method of the invention to be useful and concrete, and provide a tangible result, the following conditions under the IRC should be satisfied.

(1) Any transfer of equity to the tax-exempt organization must not be considered to be such a gift that would require the payment of a gift tax by the owner of the property.

(2) The acquisition by the tax-exempt organization of the equity cannot be considered to be “acquisition indebtedness” that would convert rental income to unrelated taxable income.

(3) The Organization must not manage the property and must remain a passive party.

(4) Property must be owned by the donor for one year before a 100% contribution credit is allowed.

(5) The owner's basis in the property must be higher than the contributed amount. Otherwise, the owner will be taxed as usual under the same tax circumstances as a common straight sale.

(6) The real property cannot, at any time after the acquisition, be leased by the qualified organization to the person donating the property or interest in such property to the person selling the property to the organization, or to any person who bears a relationship to the donor.

If any one of the aforementioned events occur, this may substantially diminish or eliminate the usefulness of the method.

The following sections of the IRC may be particularly relevant to the method:

IRC Section 511. Although tax exempt organizations are normally not taxable under the IRC, Section 511 imposes a tax on “unrelated business income” of tax exempt organizations that would normally be exempt under Sections 401(a) and 501(c). For such tax-exempt organization, “taxable income” means “unrelated business taxable income.”

IRC Section 512. Section 512 defines “unrelated business taxable income,” the general rule being that the “unrelated business taxable income” of a tax exempt organization is the gross income derived by any such organization by an unrelated trade or business, less any deductions allowed by the IRC, that are directly connected with the carrying on of such trade or business, just as for a normal, for-profit corporation.

IRC Section 513. Section 513 defines “unrelated trade or business” of a tax exempt organization. In general, a trade or business is “unrelated” when its conduct is not substantially related to the exercise or performance by the tax-exempt organization of its charitable, educational or other purposes or functions that constitute the basis of its exemption under Section 501. It is noted that the general rule does not apply and does not include a trade or business in which substantially all the work in performing such trade or business is done for the organization without compensation.

Section 514 IRC. This Section defines unrelated debt-financed income and deductions in computing taxes under Section 512, the unrelated business taxable income with debt-financed property is defined by the Section as any property that is held to produce income and with respect to which there is an acquisition indebtedness at any time during the tax year. Further research will find that under certain qualifying conditions, colleges are not taxed in receiving unrelated business income immaterial of properties having debt when donated. For clarification, acquisition indebtedness is defined by the IRC, with respect to any debt-financed property, as the unpaid amount of the indebtedness incurred or received by the organization in acquiring or improving such property, or the indebtedness incurred before the acquisition or improvement of such property, if such indebtedness would not have been incurred but for such acquisition or improvement, and if the incurrence of such indebtedness was reasonably foreseeable at the time of the acquisition or improvement. Of course, when a property is acquired subject to a mortgage or other similar lien, the amount of the indebtedness secured by the mortgage or lien is considered to be the indebtedness of the organization incurred in acquiring the property.

Section 514(c)(9) IRC. This subsection specifically addresses when real property is acquired by a qualified tax-exempt organization. Generally, “acquisition indebtedness” includes indebtedness by a qualified organization in acquiring real property. In order to comply with the general rule that acquisition indebtedness has been incurred, the following conditions must be met:

i. The price of the acquisition must be a fixed amount determined as of the date of the acquisition. If the price for the acquisition is not a fixed amount, the rule does not apply.

ii. The amount of the indebtedness may not be dependent, in whole or in part, on any revenue, income or profits derived from the real property. If it is so dependent, the rule does not apply.

iii. The real property cannot at any time after the acquisition be leased by the qualified organization to the person selling such property or interest in such property to the person selling the property to the organization, or to any person who bears a relationship to the seller.

iv. The person transferring the interest cannot provide the organization with financing in connection with the acquisition or improvement.

v. Organization cannot be an active partner in the venture nor the operation of property (must be passive), i.e., college cannot provide services to the tenants, etc.

vi Owner must retain the property for a minimum of one year.

Therefore, all of the aforementioned requirements that are relevant to the present method must be satisfied so that no exceptions apply.

SECTION 170 IRC. With regard to charitable gifts and contributions, the general rule under this Section is that a deduction is allowed for any charitable contribution the payment of which is made within the taxable year, and wherein the charitable deduction is allowable as a deduction if it can be properly verified. The deductibility aspect is more specifically found under Section 170(a)(4) and 170(f)(5) as well as Regulation 1011-2(a). Thus, a charitable contribution to an educational organization that normally maintains a regular faculty and curriculum, and normally has a regularly enrolled body of pupils or students in attendance at the place where its educational activities are regularly carried on, results in a deduction that avoids payment of a gift tax.

SECTION 501(c)(3) This section provides for colleges only to be exempt from income received from real estate (“unrelated business income tax) subject to those same main conditions stated herein.

Debt-Financed Income. As suggested above, Section 514(c) of the IRC provides an exclusion from the definition of acquisition indebtedness, certain indebtedness incurred by an educational organization, described in Section 170(a)(4), 170(f)(5) and Reg. 1011-2(a). In order to qualify for the exclusion, it is necessary among other restrictions, that after the sale and/or donation of the property the property not be leased to the seller and that none of the financing on the property be provided by the seller to a related party. Although many more factors may come into play and may need to be known regarding the overall transaction in any given application, it appears that the transfer of equity and balance of debt to a tax exempt organization does not constitute acquisition indebtedness and would, therefore, not convert the rental income to unrelated taxable income.

Partial-Interest Gift. The partial-interest gift of Section 170 allows taxpayers who make a contribution to colleges of many types of partial interests in property deductions from their contributions from the taxpayer's income tax.

The basic methodology, therefore, includes the following major steps:

1. A Joint Venture is formed between the owner/donor and the college. The owner/donor is to maintain total management of the property during the “phantom income” tax period until debt retirement (in whole or in part) from lease income. Vesting to be in the name of the college and the owner.

2. Concurrently with the execution of the Joint Venture Agreement, the owner is to donate property in part to a college tax-exempt organization subject to new or existing debt.

3. Upon retirement of debt, the property will be sold or refinanced, and/or a purchase of the other party's interest can be made in accordance with their Buy-Sell Agreement.

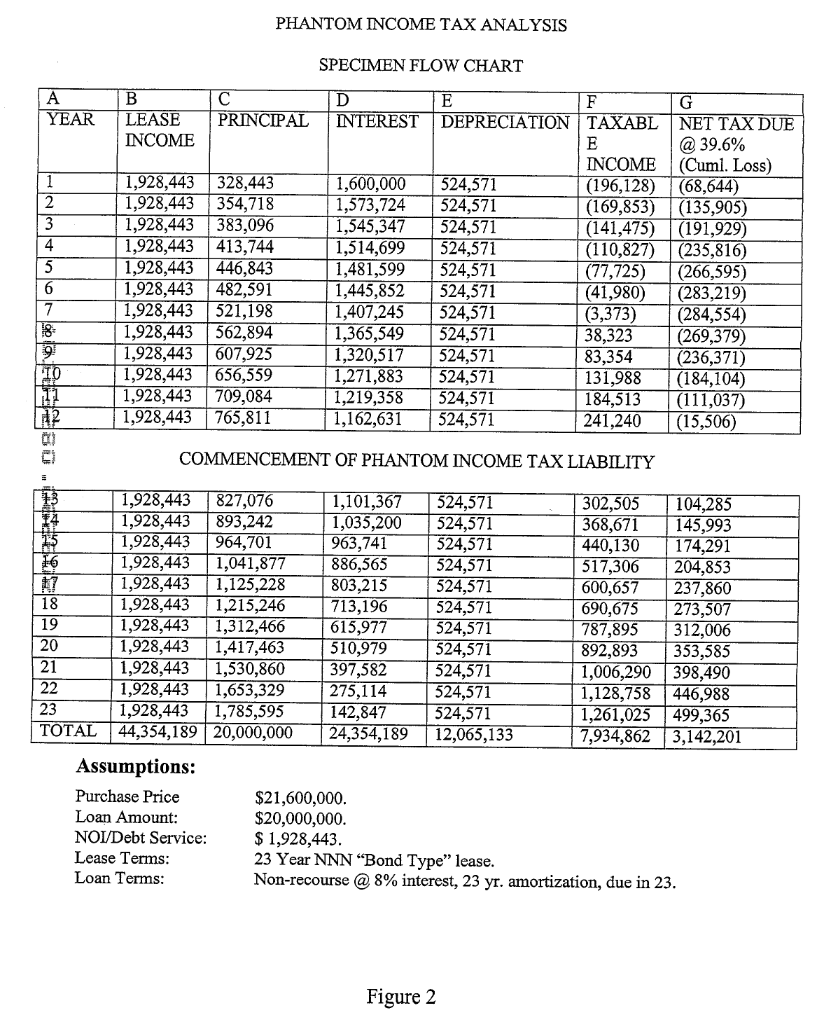

Typically, the income-producing property is donated, in whole or in part, to a tax-exempt college prior to the “cross-over” period (e.g., year 12 in FIG. 2).

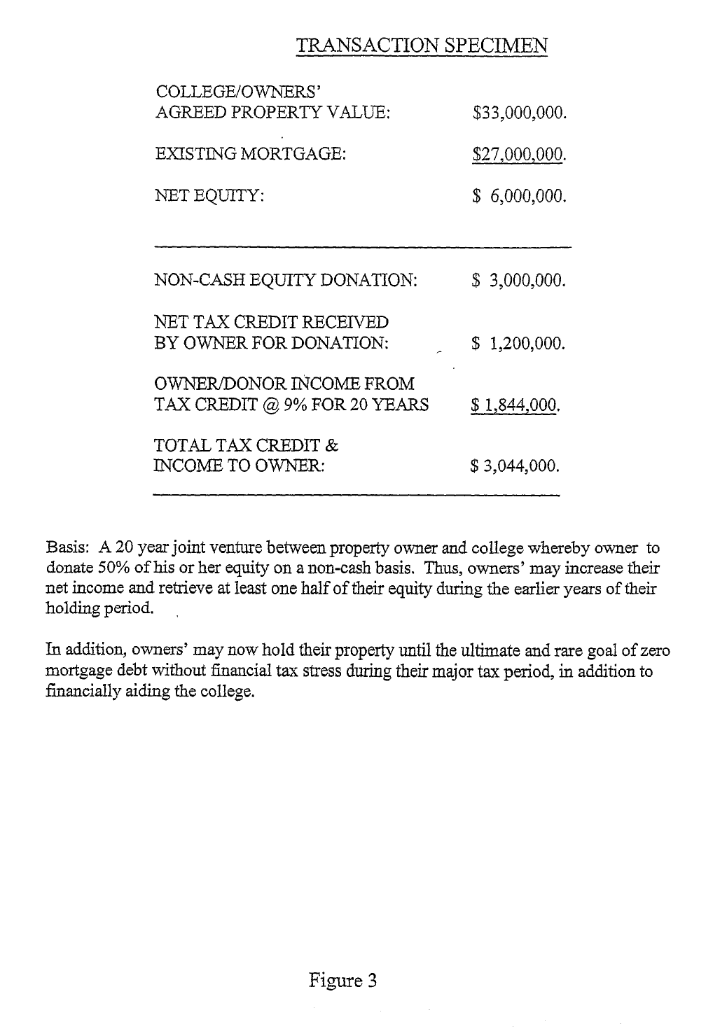

Referring to FIG. 3, it will be noted that in the example shown, the property, valued at $33,000,000, is subject to a mortgage of $27,000,000. The annual debt expense will service fixed monthly mortgage payments of interest and principal fully amortized in 20 years. The balance of the initial lease term is also 20 years. The lease is based on a “net net net” (“NNN”) “bond-type” lease. It will be noted from FIG. 2 that while the lease income is fixed for all 23 years, that portion which is attributable to interest starts, in year 1, with $1,600,000.00, and is ultimately reduced to $142,847.00 in year 23. Assuming a 20-year due date, the loan balance would be approximately 29%, allowing the venture reasonable profit.

At the same time, the amount attributable to principal operates in the reverse way. That is to say, it starts at its lowest value of $328,443.00 in the first year of the mortgage, and increases to $1,785,595.00 in year 23. Since only the interest is deductible against lease income, and with depreciation shown to be a straight line over the 23-year period, it will be evident that the taxable income increases from negative taxable income, or a loss of deduction to a significant positive taxable income of $1,261,025.00 in year 23. The net tax due, at the 39.6% tax bracket, is shown to be a negative tax for the first 12 years, after which the “phantom income tax” liability period commences. The period between the years 12 and 13, therefore, is termed, in this application, the “cross-over” period, in which the net tax due changes from a negative tax to a positive tax. The positive tax continues and increases from $104,285.00 to $499,365.00 in year 23. It will be immediately noted therefore, that under the conditions specified, the payment of the income tax can be a tremendous hardship on the owner of the property, and possibly make it impossible for the owner to pay the taxes with the fixed lease income available to him or her.

The four main goals of this invention is clearly achieved by:

(a) creating income to tax-stressed property owners:

(b) providing needed financial assistance to educational organizations whose tuitions are ever-increasing;

(c) providing relief for the donating public (alumni, etc.); and

(d) providing some relief of pressure that an ever-increasing portion of State and Federal Government funds be allocated to colleges, hopefully resulting in relief to the public.

What I claim:

1. A method of increasing the return to an owner of investment real estate property subject to a mortgage that is self-amortizing over a period of years with a balance less than the market value of the property, leaving dormant equity in the owner and generating lease income, comprising the steps of:
a. appraising the property to obtain a fair market value;
b. creating ajoint venture between the owner and an organization exempt from taxation under prevailing tax laws;
c. donating to said organization, by the owner of the property, a percentage of the dormant equity in the property without creating acquisition indebtedness and without creating a gift taxable under prevailing tax laws;
d. servicing the mortgage and managing the property by the owner over a period of years until the mortgage is extinguished or retired with lease income, and the balance is reduced to zero;
e. paying income taxes during the mortgage servicing period on the retained percentage representing the owner's share in the principal reduction amount in the mortgage;
f. selling the property by the joint venture after the mortgage retirement date for a predetermined selling price; and
g. distributing the net proceeds to the owner and to the organization in accordance with the percentages in said joint venture.

2. A method as defined in claim 1, wherein the amount donated to the organization is an amount less than the owner's basis in the property.

3. A method as defined in claim 1, wherein the owner enters into a donation commitment agreement prior to the creation of the joint venture.

4. A method as defined in claim 1, wherein the organization executes an acknowledgment of said donation following the donation by the owner.

5. A method as defined in claim 1, wherein the donor issues and the organization accepts a grant deed after a formal donation to the organization has been executed.

6. A method as defined in claim 1, wherein the owner grants 50 percent of said dormant equity to the organization.

7. A method as defined in claim 1, wherein the owner retains the property for at least one year prior to seeking 100 percent contribution credit.

8. A method as defined in claim 1, wherein the property is leased to a party other than the owner or to any person who bears a relationship to the owner.

9. A method as defined in claim 1, wherein the property is transferred to the joint venture subject to the owner to re-purchase the property.

10. A method as defined in claim 1, wherein the organization is an educational organization.

11. A method as defined in claim 1, wherein acquisition indebtedness is avoided by complying with Section 514(c)(9) of the Internal Revenue Code, thereby preventing conversion of the lease rental income to unrelated taxable income.

12. A method as defined in claim 1, wherein the transfer of partial equity by the owner to the organization satisfies Section 170(f)(3) of the Internal Revenue Code to avoid an income tax partial-interest gift restriction and thereby avoiding a gift tax by the owner.

13. A method as defined in claim 1, wherein the transfer of partial equity by the owner to the organization satisfies Section 2522(c) of the Internal Revenue Code to avoid an income tax partial-gift restriction and thereby avoiding a gift tax by the owner.

14. A method as defined in claim 1, wherein the method is implemented prior to a mortgage cross-over period.

15. A method as defined in claim 1, wherein the method is implemented substantially about the time of a mortgage cross-over period.

16. A method as defined in claim 1, wherein said steps of creating a joint venture and donating an interest in the property are performed concurrently.
